(19) United States
(12) Patent Application Publication
(10) Pub. No.: US 2010/0214615 A1
(43) Pub. Date: Aug. 26, 2010

(54) Method for Producing a Printed Product

(75) Inventors: Peter Schulmeister, Pfaffenhofen (DE); Robert Weiss, Gersthofen (DE); Florian Fejfar, Munchen (DE)

Correspondence Address: COHEN, PONTANI, LIEBERMAN & PAVANE LLP, 551 FIFTH AVENUE, SUITE 1210, NEW YORK, NY, 10176, US

(73) Assignee: manrolanad AG, Offenbach am Main (DE)

(21) Appl. No.: 12/680,675

(22) PCT Filed: Sep. 26, 2008
(86) PCT No.: PCT/EP08/08222

§ 371 Date: Apr. 20, 2010

(30) Foreign Application Priority Data
Sep. 29, 2007 (DE) 10 2007 046 809.3

(51) Int. Cl. G06K 15/02

(52) U.S. Cl. 358/1.18

(57) ABSTRACT

A method for producing a printed product, wherein at least one printing substrate webs are transported through at least one printing form-based printing unit for static printing of at least one printing substrate webs with a printed image which remains unchanged for printed copies of the printed product. In addition, at least one of the statically printed printing substrate webs is printed inline dynamically with the static printing in a region of at least one printing device of the web press without a printing form with access data, e.g., a prize code, which is individualized for at least some printed copies. Here, information content, such as a prize, which extends beyond the printed product can be accessed by the access data for a purchaser of the printed product over an interactive medium, such as the Internet. Access data specific to a target person and/or a target group are printed in the printed copies as individual access data.

### CROSS-REFERENCE TO RELATED APPLICATIONS

This is a U.S. national stage of International Application No. PCT/EP2008/008222, filed on 26 Sep. 2008. Priority is claimed on German Application No. 10 2007 046 809.3, filed on 29 Sep. 2007.

### BACKGROUND OF THE INVENTION

1. Field of the Invention

The invention is directed to a method for producing a printed product.

2. Detailed Description of the Related Art

Web presses have printing form-based printing units for statically printing at least one printing substrate web with a printed image which is the same for all printed copies of a printed product. Every printed copy usually comprises a plurality of printed pages. Printing form-based printing units of this kind, which serve for static printing on the printing substrate web, or on each printing substrate web, are typically constructed as offset printing units. It is also possible that printing form-based printing units are constructed as intaglio printing units.

It is known to provide in a web press, in addition to the printing form-based printing units serving for static printing of the printing substrate web, or of each printing substrate web, with a printed image which is the same for all printed copies, at least one printing device without a printing form so as to individualize printed copies in addition to the static printing, i.e., to dynamically print with a printed image which varies for at least some printed copies. A printing device of this kind without a printing form can be an inkjet printing device or an electrophotographic printing device, such as a laser printing device or an ionographic printing device.

Further, it is known to dynamically print printed copies with individualized access data, i.e., with a prize code, so that information content, such as a prize, extending beyond the printed product can be accessed by the access data for a purchaser of the printed copy by an interactive medium, such as the Internet.

For example, it is known from practice that a purchaser of a printed copy which is individualized by an individual prize code uses the prize code of the printed copy to register personal data over the Internet, such as with the publisher of the printed copy, in order to participate in a contest, where the purchaser must acquire, for example, additional products or services particularly of the publisher to claim possible prizes. In this way, an added value can be generated for a purchaser of the printed product as well as for a publisher of the printed product.

In conventional methods for producing the above-mentioned printed products, the dynamic access data for individualizing statically printed products are not specific to a target person or to a target group, i.e., a link is only established between the individualized access data of a printed copy and a purchaser of the printed product using the interactive medium.

### SUMMARY OF THE INVENTION

It is therefore an object of the present invention to provide a method for producing a printed product. This and other objects and advantages are achieved by a method in accordance with the invention in which access data specific to a target person and/or access data specific to a target group are printed in the printed copies as individual access data.

Within the meaning of the invention, individual access data in the dynamic printing of printed copies are access data specific to a target person and/or access data specific to a target group. Accordingly, a link can be established to a certain extent already in the printing stage between the individual access data to be printed dynamically in the printed copy and data of the recipient or of a group of recipients of the corresponding printed product. In this way, printed products can deliberately be made dynamic with individual access data so as to enhance the success, of a marketing campaign.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment examples of the invention are described more fully with reference to the drawing without limiting the invention, in which:

The FIGURE is a schematic diagram illustrating the method for producing a printed product in accordance with an embodiment of the invention.

### DETAILED DESCRIPTION OF THE PREFERRED EMBODIMENTS

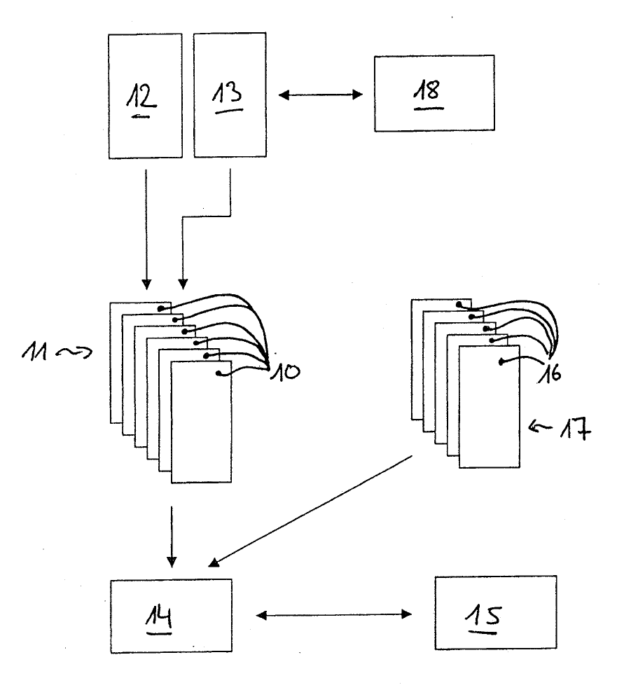

The invention is directed to a method for producing a printed product, such as a newspaper. The method in accordance with the invention is described in the following with reference to FIG. 1 which schematically shows a plurality of printed copies 10 of a printed product 11 to be produced. During the production of the printed product 11, at least one printing substrate web is statically printed based on static data 13 with a printed image which remains the same for all of the printed copies 10 of the printed product 11. The printing of the printing substrate web, or of each printing substrate web, based on static data 12 with the printed image which stays the same for all printed copies 10 is performed in at least one printing form-based printing unit which is constructed, e.g., as an offset printing unit.

During the production of the printed product 11, in addition to the static printing, at least one of the statically printed printing substrate webs is printed dynamically based on dynamic data 13 with a printed image which is individualized for at least some printed copies 11. The individual printed image that is printed based on the dynamic data 13 contains access data. The dynamic data are printed on at least one printing substrate web by at least one printing device without a printing form, i.e., at least one inkjet printing device.

A printed copy 10 of the printed product 11, which is produced in the manner described above with a static printed image and a dynamic printed image, is acquired by a purchaser 14. The purchaser 14 of a printed copy 10 uses the access data printed in the printed copy 10 as dynamic printed image to access, using an interactive medium 15, information content which extends beyond the printed product 11 and, therefore, beyond the printed copy 10.

The access data which are printed dynamically in the printed copes 10 and are individualized for at least some printed copies can be, e.g., web addresses, on the basis of which a purchaser 14 accesses additional information content or enters data in a database using the interactive medium 15. Further, the individual access data can be telephone numbers, radio broadcaster information and television broadcaster information or a prize code which motivates a purchaser 14 of a printed copy 10 to access additional information content over the corresponding interactive medium 15, such as over the Internet, radio, television or by telephone.

When the access data printed in the printed copies 10 constitute a prize code, a purchaser 14 of a printed copy 10 can register, such as over the Internet, with the publisher of the printed copy by making use of the prize code to participate in a contest, and the purchaser 14 must then acquire a product, i.e., a printed copy 16 of another printed product 17, or a service, such as to check whether a prize has been awarded to the purchaser 14. The access data specific to a target person and/or target group which are printed in the printed copies are accordingly linked to a product and/or service. In this way, an added value can be generated for the purchaser of the printed product 11, as well as for the publisher thereof.

In accordance with the invention, the dynamic printed image printed in the printed copies 10 of the printed product 11 as individual access data is access data specific to a target person and/or access data specific to a target group.

Accordingly, it is within the scope of the invention that the individual access data which are printed in the printed copies 10 of the printed product 11 are designed depending on the recipient and/or on a group of recipients of the printed product 11. For this purpose, the dynamic data 13, on the basis of which the dynamic printing of the printed copies 10 of the printed product 11 is performed, can be compared to a database 18 containing the data specific to the target person and/or specific to the target group. The database 18 can be, e.g., a content management system (CMS).

By means of the invention it is possible, e.g., with knowledge of the specific recipient or subscriber of the printed product 11, to print a printed copy 10 intended for this subscriber with individual access data specific to this subscriber.

Accordingly, for example, personal data of the specific subscriber, such as the profession of the subscriber or the brand of car driven by the subscriber, can be stored in the content management system so that access data of this kind can be printed in the printed copy 10 of the subscriber to motivate the subscriber to access information content extending beyond the printed product 11 using the interactive medium 15.

It is also possible to dynamically print individual access data in the printed copies 10 of the printed product for a certain group of recipients, such as, for a readership or for printed copies 10 of the printed product 11 distributed in a certain region.

Based on the data specific to a target person and/or the data specific to a target group which are stored in the database 18, Internet user accounts with web offers specific to a target person and/or specific to a target group can also be pre-generated, and the recipient of the printed product 11 can then access these user accounts using the access data specific to a target person and/or specific to a target group which are printed in the printed product 11.

The access data specific to a target person and/or specific to a target group are printed such that they are printed on at least one printed page inside the respective printed copy. The access data specific to a target person and/or specific to a target group are then not visible from the outside, but rather the access data is only visible when the printed copy is opened. The access data specific to a target person correlate with logistical data of the recipient.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for producing a printed product, comprising:
transporting at least one printing substrate web through at least one printing form-based printing unit for static printing of a printed image on the at least one printing substrate web, the printed image remaining unchanged for all printed copies of the printed product; and
dynamically printing access data on at least one of the at least one statically printed printing substrate web in a region of at least one printing device of the web press without a printing form, the access data being individualized for at least some of the printed copies, the access data providing to a purchaser of the printed product access to information content extending beyond the printed product though an interactive medium, the step of dynamically printing access data including printing access data specific to at least one of a target person and a target group in the printed copies as individual access data.

8. The method according to claim 7, wherein the access data specific to at least one of the target person and the target group is linked to at least one of a product and a service.

9. The method according to claim 7, wherein the access data is specific to the target person and depends on a recipient of the specific printed copy of the printed copies on which the access data is printed.

10. The method according to claim 8, wherein the access data is specific to the target person and depends on a recipient of the specific printed copy of the printed copies on which the access data is printed.

11. The method according to claim 9, wherein the access data is specific to the target person and correlates with logistical data of the recipient of the printed copies on which the access data is printed.

12. The method according to claim 7, wherein the access data is specific to the target group which depend on a group of recipients of specific printed copies of the printed copies on which the access data is printed.

13. The method according to claim 7, wherein the access data specific to at least one of the target person and the target group are printed on at least one printed page inside of a respective printed copy.

14. The method according to claim 7, wherein the step of dynamically printing is performed inline with the static printing.

15. The method according to claim 7, wherein the information content is a prize.

16. The method according to claim 7, wherein the interactive medium is the Internet.
